(19) United States
(12) Patent Application Publication
(10) Pub. No.: US 2015/0230288 A1
(43) Pub. Date: Aug. 13, 2015

(54) HEATING APPARATUS FOR VISCOUS BODY AND METHOD FOR USING SAME

(71) Applicant: Chi Zhang, Guangzhou (CN)

(72) Inventor: Chi Zhang, Guangzhou (CN)

(21) Appl. No.: 14/174,906

(22) Filed: Feb. 7, 2014

(51) Int. Cl. H05B 1/02; H05B 3/78

(52) U.S. Cl. CPC H05B 1/0244; H05B 3/78

(57) ABSTRACT

A heating apparatus. The heating apparatus further comprises a heating element, and a temperature regulating unit, wherein the temperature regulating unit causes the heater to stop producing heat once a specified temperature has been reached.

### FIELD OF THE INVENTION

The present invention is directed to a heating apparatus, and, more particularly, to heating apparatus that may be applied to a viscous body such as asphalt, sealant, or bitumen.

### BACKGROUND OF THE INVENTION

From time to time, a viscous body must be heated in order to be applied and used. In this application, “viscous body” refers to any material with high viscosity at or around room temperature which decreases in viscosity upon the application of heat, for example but not limited to asphalt, driveway sealant, bitumen, or other road-repair preparations.

There are several existing methods and devices for heating a viscous body prior to application. For example, heated air, steam, or oil can be applied to the viscous body. Likewise, a wire or heating element can be placed in or near the viscous body. Other heating methods include the application of infrared light, electromagnetic forces, or fire may be used. The viscous body can coke or otherwise materially change if it is subject to uncontrolled heating or overheating. Generally, these heating methods are scaled for industrial and commercial use, such as the construction of an entire building or an entire driveway; they are therefore not cost-effective for occasional use by a homeowner or small business that requires only a small capacity.

### SUMMARY OF THE INVENTION

The present invention resides in one aspect in a heating apparatus. The heating apparatus has a heating element, a handle, a temperature regulating unit, and a power source. The temperature regulating unit causes the heating element to stop producing heat once a specified temperature has been reached.

### BRIEF DESCRIPTION OF THE DRAWINGS

FIG. 1 is a side view of the heating apparatus; and

FIG. 2 is a side view of one embodiment of the heating apparatus showing a user interface.

### DETAILED DESCRIPTION

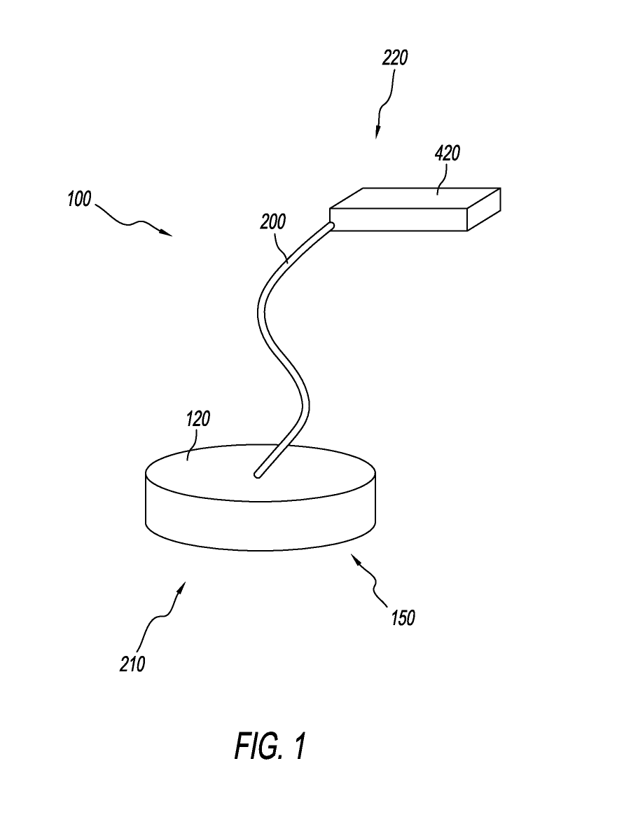

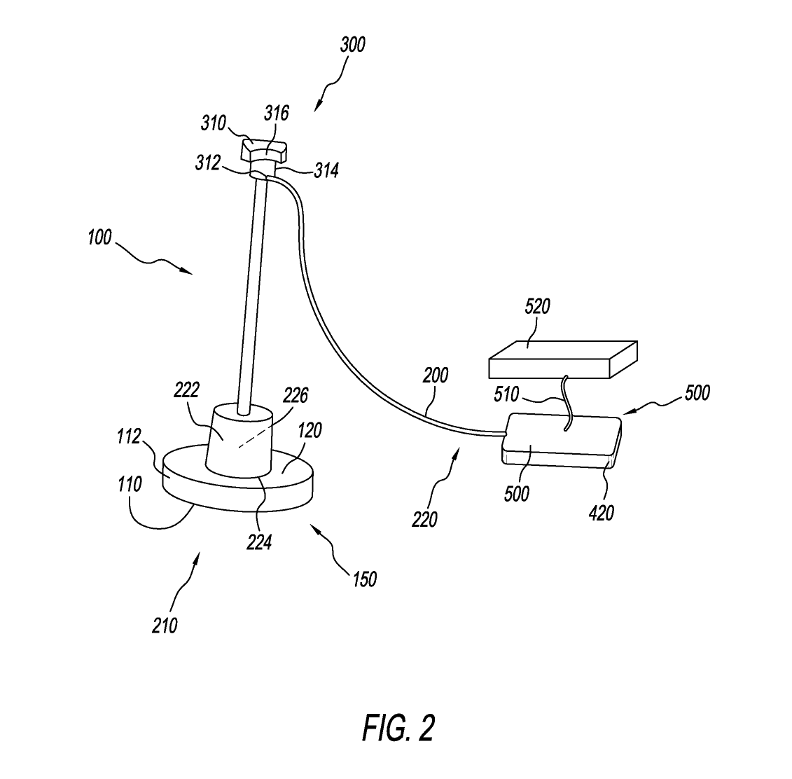

As shown in FIGS. 1 and 2, a heater apparatus 100 is disclosed, comprised of a heating element 120 at a heater end 150 connected to a power source 420 by a heating cable 200. The heater end 150 may be disposed in a heat-resistant container containing a viscous body, which is not shown. The viscous body is any material with high viscosity at room temperature that must be softened or melted in order to be applied, such as, for example, asphalt, bitumen, driveway sealant, or crack sealer.

As shown in FIG. 2, in one embodiment, the heating element 120 is made of cast metal. Each component part of the heater apparatus 100 may be composed of the same material, or of different materials. A heating plate 110 is disposed inside a heating element casing 112. In one embodiment, the heating plate 110 is be heated by a resistive heater wire. In another embodiment, the heating plate 110 is heated by an electromagnetic coil. It is understood that the means of converting electric energy into heat energy in the heating plate 110 is not limited by these listed commercial embodiments.

The heating element 120 is sized to fit inside a container, such as, for example, a bucket, tub, tin, or bag containing the viscous body. In one embodiment, the container is a proprietary canister holding approximately 8 liters of the viscous body (e.g., DSeal Driveway Repair™, a trademark of OrderBid International, Guangzhou, Guangdong, China). It is understood that containers of different volumes, shapes, and materials may be interchanged without departing from the present invention.

The heating plate 110 causes the viscous body to attain a temperature up to or exceeding 392° Fahrenheit. As shown in FIG. 2, in one embodiment, a user interface 520 is connected to a temperature control module 500 by a connecting cable 510. The user interface 520 permits a user to select the temperature at which point the heating element 120 will stop producing heat. A temperature sensor, not shown, is connected to the temperature control module 500 and reads the internal temperature of the viscous body. The temperature control module 500 is in communication with the heating plate 110 via the connecting cable 510 and heating cable 200. The temperature of the heating plate 110 is controlled by any arrangement known in the art, such as, for example, a wire or series of wires and switches. In one embodiment, the temperature control module 500 triggers the shutoff at 392° F. In another embodiment, the temperature control module 500 triggers the heat shutoff at 374° F. In another embodiment, the temperature control module 500 triggers the heat shutoff at 356° F. In another embodiment, the temperature control module 500 triggers the heat shutoff at 302° F. In another embodiment, the temperature control module 500 triggers the heat shutoff at 221° F. In another embodiment, the temperature control module 500 triggers the heat shutoff at 147.2° F. In yet another embodiment, the temperature control module 500 triggers the heat shutoff at any temperature by user input. It is understood that the temperature control module 500 may be triggered at any temperature.

As shown in FIG. 2, in one embodiment, the heater plate 110 is disposed within a case 112. In one embodiment, the case 112 is water-tight. In another embodiment, the case 112 is composed of a heat-resistant material, such as, for example a thermosetting polymer. In another embodiment, the case 112 directs the heat produced by the heater plate 110 in one direction only, such as, for example, away from the heating cable 200. In another embodiment, the case 112 protects the heater plate 110 without limiting the directionality of the heat thereby produced. In yet another embodiment, the case 112 is formed such that a user may aim or control the directionality of the heat produced by the heater plate 110.

As show in FIG. 2, in one embodiment, the case 112 is fixedly attached to a power cable casing 222. In another embodiment, the case 112 is contiguous with the power cable casing 222. In another embodiment, the case 112 and the power cable casing 222 are formed of the same heat-resistant and water-tight material. In another embodiment, the case 112 is removably attached to the power cable casing 222.

As shown in FIGS. 1 and 2, the heating cable 200 has a heating end 210 and a controller end 220. The heating cable 200 is connected to the heating element 120 at the heating end 210 by a coupling 226 disposed within the connection cover 224. In one embodiment, the connection cover 224 is made of heat-resistant material, such as, for example a thermosetting polymer. In another embodiment, the connection cover 224 is water-tight. In another embodiment, the connection cover 224 is removably attached to the case 112. In another embodiment, the connection cover 224 is removably attached to the power cable casing 222. Each component part of the heating cable 200 may be composed of the same material, or of different materials.

As shown in FIG. 2, in one embodiment, the controller end 220 of the heating cable 200 terminates in a handle end 300. In one embodiment, a handle 310 is fixedly attached to a power cord coupling 312 disposed within a cover 314. In one embodiment, the cover 314 is made of heat-resistant material. In another embodiment, the cover 314 is water-tight. In another embodiment, the cover 314 is removably attached to the coupling 312. In another embodiment, the cover 314 is removably attached to the handle 310. In yet another embodiment, the cover 314 is contiguous with the coupling 312. In another embodiment, the coupling 312 and the cover 314 are formed of the same heat-resistant and water-tight material.

In one embodiment, the cover 314 is fixedly attached to the handle 310. In another embodiment, the cover 314 is removably attached to the handle 310. In yet another embodiment, the cover 314 is contiguous with the handle 310. In another embodiment, the handle 310 and the cover 314 are formed of the same heat-resistant and water-tight material.

Each component part of the handle end 300 may be composed of the same material, or of different materials. In one embodiment, the handle 310 is composed of heat-resistant plastic, such as, for example a thermosetting polymer. In another embodiment, the handle 310 is composed of wood. In one embodiment, the handle 310 is sized to be easily gripped by one hand of a user. In one embodiment, the handle 310 has one or more recessed areas 316 which provide additional surface area, for example, by which a user may securely grip the handle 310. In another embodiment, the handle 310 is cylindrical. In yet another embodiment, the handle 310 has an asymmetrical shape.

In one embodiment, the heater plate 110 is of sufficient mass such that, as the temperature of the viscous body increases and the viscous body reduces in viscosity, the heater end 150 will sink towards the bottom of the viscous body. In another embodiment, a user may grip, push, or hold the handle 310 and manipulate the heater 100.

It is contemplated that a variety of types of viscous body may be suitable for uses to which the present invention is applicable. Materials having properties rendering them substantially viscous at room temperature are well-known in the art, and are readily commercially available. The present invention need not be used in conjunction with any proprietary container and is not limited to any specific viscous body.

It is understood that in other embodiments of the present invention the user interface 520 may operate wirelessly or by other computer-controlled means and need not be fixedly attached to the heating apparatus 100. It is understood that in other embodiments of the present invention, the temperature control module 500 may operate wirelessly or by other computer-controlled means and need not be fixedly attached to the heating apparatus 100.

A number of embodiments of the invention have been described. Nevertheless, it will be understood that various modifications may be made without departing from the spirit and scope of the invention. Accordingly, other embodiments are within the scope of the following claims.

What is claimed is:

1. A heating apparatus comprising:
a heating element; and
a temperature regulating unit;
wherein the temperature regulating unit causes the heating element to stop producing heat once a specified temperature has been reached.

2. The heating apparatus of claim 1 further comprising a handle.

3. The heating apparatus of claim 1 wherein the heating apparatus is suspended in or near a viscous body.

4. The heating apparatus of claim 3 wherein the viscous body is asphalt.

5. The heating apparatus of claim 3 wherein the viscous body is bitumen.

6. The heating apparatus of claim 2 further comprising a heat-resistant handle.

7. The heating apparatus of claim 6 wherein a heat-resistant casing extends between the heating element and the handle.

8. The heating apparatus of claim 1 wherein the heating element is cast tube parts.

9. The heating apparatus of claim 6 wherein the heat-resistant handle is made of wood.

10. The heating apparatus of claim 6 wherein the heat-resistant handle is made of heat-resistant plastic.

11. The heating apparatus of claim 1 wherein the heating element is made of cast metal.

12. A method of heating a viscous body comprising:
disposing a heating element proximate to a viscous body, heating the heating element, dispersing heat to the viscous body, setting a maximum temperature for the viscous body, sensing the temperature of the viscous body, ceasing to heat the heating element when the temperature of the viscous body reaches the set maximum temperature.

13. The method of claim 11 further comprising disposing the heating element by a handle.

14. The method of claim 11 further comprising disposing the heating element proximate to the viscous body contained in a container of 8 liters or less.

15. The method of claim 11 further comprising adjusting the maximum temperature by a user interface.

16. The method of claim 11 further comprising setting the maximum temperature no hotter than 392° Fahrenheit.
